(19) United States
(12) Patent Application Publication
(10) Pub. No.: US 2024/0048003 A1
(43) Pub. Date: Feb. 8, 2024

(54) Rotationally-Locking Magnetic Alignment System

(71) Applicant: Google LLC, Mountain View, CA (US)

(72) Inventors: Alex Sebastian Hans, San Francisco, CA (US); Jaeun Park, San Francisco, CA (US); Jeffrey Alexander Sizemore, San Francisco, CA (US); Jean Soo Hyun, San Francisco, CA (US)

(73) Assignee: Google LLC, Mountain View, CA (US)

(21) Appl. No.: 18/490,504

(22) Filed: Oct. 19, 2023

Related U.S. Application Data
(60) Provisional application No. 63/507,684, filed on Jun. 12, 2023.

(51) Int. Cl. H02J 50/90; H02J 50/10; H04M 1/04

(52) U.S. Cl. CPC H02J 50/90; H02J 50/10; H04M 1/04

(57) ABSTRACT

The various embodiments of a rotationally-locking magnetic alignment system and components thereof are described herein, which enable position locking and self-alignment along stepwise rotational increments. In aspects, a rotationally-locking magnetic alignment system can include magnetic alignment components, where each magnetic alignment component can include an array of magnetic field-inducing components that possess a particular magnetic polarity such that a first magnetic alignment component can attract, magnetically couple, and positionally lock a complementary second magnetic alignment component. In implementations, the array of magnetic field-inducing components can be arranged in one or more patterns, within the first magnetic alignment component and/or the second magnetic alignment component, allowing for the first magnetic alignment component to be positionally locked at any number of stepwise rotational increments.

### BACKGROUND

The use of wireless charging for mobile devices is rapidly increasing. The Wireless Power Consortium (WPC) has developed an open interface standard, referred to as Qi, which has been implemented into a majority of the mobile devices today that use wireless charging. Qi standards provide high-efficiency inductive charging at 5-15 Watts of power at low frequencies (e.g., 87-205 kHz) over distances of up to four centimeters. Efficiency is highest when a wireless charger has a transmitting inductive coil that substantially matches the size of a receiving inductive coil at the mobile phone and the coils are aligned. Misalignment and mismatched sizes of the coils significantly reduces the efficiency of power transfer.

Qi2 is the next version of the Qi wireless charging standard. A notable update in the Qi2 wireless charging standard will be the utilization of magnets to facilitate the alignment of a wireless charging coil in an electronic device and a wireless charging coil of a magnetic wireless charger. In this way, magnetic wireless chargers can snap into place on the rear of electronic devices, providing a secure alignment for the induction coils. Because of its improved efficiency and interoperability, Qi2 is expected to enable faster charging for electronic devices and pave the way for safe and energy-efficient charging.

### BRIEF DESCRIPTION OF THE DRAWINGS

The details of one or more aspects of a rotationally-locking magnetic alignment system are described in this document with reference to the following drawings. The same numbers are used throughout the drawings to reference like features and components:

FIG. 1 illustrates a front perspective view and a rear perspective view of an example constrained electronic device;

FIG. 2 illustrates a first stage and a second stage of the example constrained electronic device and an auxiliary equipment;

FIG. 3 illustrates an example environment that includes example constrained electronic devices, which are capable of implementing a magnetic alignment component in accordance with one or more implementations;

FIG. 4A illustrates a first detail view, a second detail view, and a third detail view of example magnetic alignment components;

FIG. 4B illustrates components of two example alignment systems;

FIG. 5 illustrates an example environment that includes example auxiliary equipment, which are capable of implementing a complementary magnetic alignment component in accordance with one or more implementations;

FIG. 6 illustrates an example environment in which the auxiliary equipment also wirelessly charges the constrained electronic device; and

FIG. 7 illustrates a block diagram illustrating an example system using the induction coil for wireless charging of the constrained electronic device.

### DETAILED DESCRIPTION

### Overview

Many electronic devices, such as smartphones and wearable devices, include wireless charging technology. However, with the Qi2 wireless charging standard replacing its predecessor wireless charging standard, Qi, future electronic devices may benefit from hardware and/or software upgrades that facilitate compatibility with future magnetic inductive wireless chargers that adhere to Qi2 wireless charging standards. Such upgrades may enable these future electronic devices to experience the benefits associated with the Qi2 wireless charging standard.

To this end, various embodiments of a rotationally-locking magnetic alignment system and components thereof are described herein, which enable position locking and self-alignment along stepwise rotational increments (e.g., increments of 45 degrees). In aspects, a rotationally-locking magnetic alignment system can include magnetic alignment components, where each magnetic alignment component can include an array of magnetic field-inducing components that possess a particular magnetic polarity such that a first magnetic alignment component can attract, magnetically couple, and positionally lock a complementary second magnetic alignment component. In implementations, the array of magnetic field-inducing components can be arranged in one or more patterns, within the first magnetic alignment component and/or the second magnetic alignment component, allowing for the first magnetic alignment component to be positionally locked at any number of stepwise rotational increments.

As described herein, a constrained electronic device may generally refer to any electronic device that is portable, includes power expenditure limitations, and/or provides at least some user-interface for user input/output. Further described herein, an auxiliary equipment (e.g., an accessory, a case, a mount, a wireless charging pad, a stand) refers generally to an appliance that can be coupled, or in any way associated with, the constrained electronic device to enhance the functionality and/or aesthetics of the constrained electronic device.

According to implementations described herein, a constrained electronic device and an auxiliary equipment can include complementary magnetic alignment components that facilitate alignment of the auxiliary equipment with the constrained electronic device and/or attachment of the auxiliary equipment to the constrained electronic device. The magnetic alignment components can include an array of magnetic field-inducing components that, in some embodiments, can surround inductive charging transmitter and receiver coils. In at least some implementations, the magnetic alignment component can also be used in a constrained electronic device or an auxiliary equipment that does not have an inductive charging coil.

These are but a few examples of how the described techniques and devices may be used to implement a rotationally-locking magnetic alignment system. Other examples and implementations are described throughout this document. The document now turns to example systems.

Example Systems

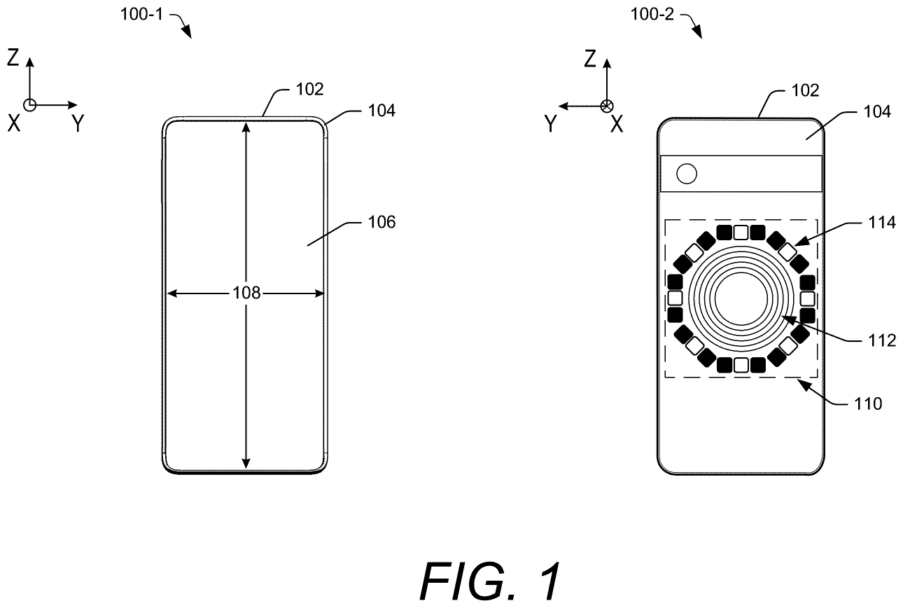

FIG. 1 illustrates a front perspective view 100-1 and a rear perspective view 100-2 of an example constrained electronic device 102. The constrained electronic device 102 includes a housing 104 that defines an internal cavity in which one or more electronic components may be housed. A cover layer 106 can be positioned over, within, or underneath portions of the housing 104 such that the housing 104 and the cover layer 106 sufficiently seal off the internal cavity (e.g., waterproof seal). Through at least portions of the cover layer 106 an active area 108 of a display panel may be visible to a user.

Further illustrated in the rear perspective view 100-2, within the internal cavity (as illustrated in region 110), an inductive coil 112 for wireless charging (e.g., transmitting, receiving) may be disposed adjacent to (e.g., within a few millimeters of) the housing 104 on the rear side of the constrained electronic device 102. A magnetic alignment component 114 that includes an array of magnetic field-inducing components may be proximate (e.g., surround, be coaxial with) to the inductive coil 112. In implementations, the array of magnetic field-inducing components can be arranged to form one or more shapes. In additional implementations, the array of magnetic field-inducing components can be arranged in one or more patterns by magnetic polarity and/or magnetic field intensity. FIG. 1 illustrates, by way of example only and not by limitation, an octagonal arrangement of magnetic field-inducing components of the magnetic alignment component 114, with each side of the octagonal arrangement including a first magnetic field-inducing component with a first magnetic polarity, a second magnetic field-inducing component with a second magnetic polarity, and a third magnetic field-inducing component with a third magnetic polarity. In one implementation, the first magnetic polarity and the third magnetic polarity are the same polarity. In another implementation, the first magnetic polarity and the second magnetic polarity are the same polarity. In yet another implementation, the second magnetic polarity and the third magnetic polarity are the same polarity. In a still further implementation, the first magnetic polarity, the second magnetic polarity, and the third magnetic polarity are the same polarity.

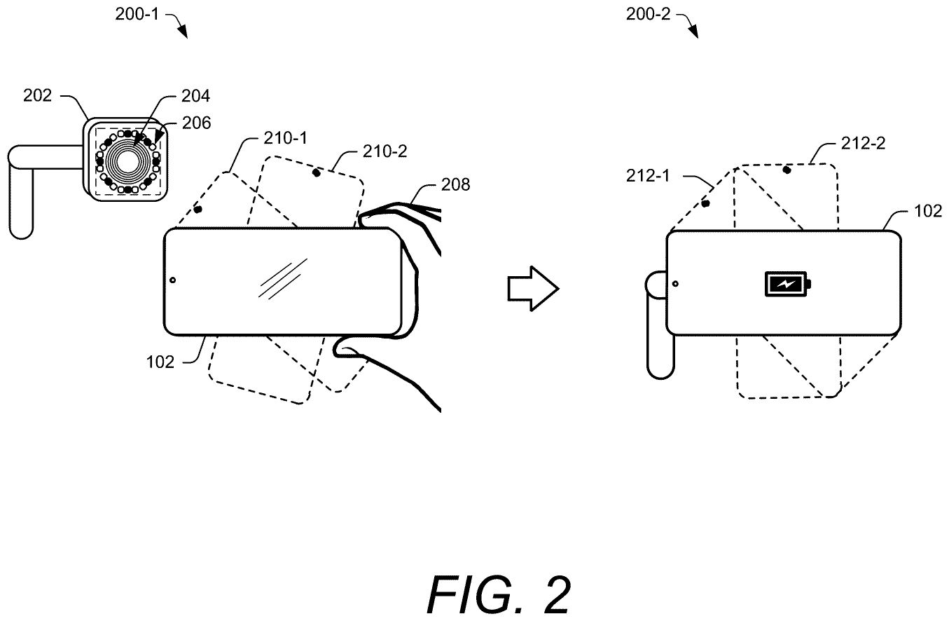

FIG. 2 illustrates a first stage 200-1 and a second stage 200-2 of the example constrained electronic device 102 and an auxiliary equipment 202. As illustrated, as an example only and not by way of limitation, the example constrained electronic device 102 is a smartphone and the auxiliary equipment 202 is an adjustable mount. In at least some implementations, the auxiliary equipment 202 is configured to wirelessly charge the constrained electronic device 102 via an inductor coil 204.

In aspects, a magnetic alignment component 206 can be disposed within the auxiliary equipment 202. The magnetic alignment component 206 can, in some implementations (not illustrated), include an annular ring of magnets. In alternative implementations, the magnetic alignment component 206 can include an array of magnetic field-inducing components positioned in an octagonal arrangement. Each of the magnetic field-inducing components can possess a particular magnetic polarity such that the magnetic alignment component 206 can attract, magnetically couple, and positionally lock the magnetic alignment component 114 disposed within the constrained electronic device 102. In implementations, the array of magnetic field-inducing components of the magnetic alignment component 206 can be arranged in a particular pattern such that the magnetic alignment component 114 of the constrained electronic device 102 can be positionally locked at any number of stepwise rotational increments. In this way, the magnetic alignment component 206 is referred to herein as being complementary to the magnetic alignment component 114.

As illustrated in the first stage 200-1, a user 208 may angle the constrained electronic device 102 in any number of polarities 210 (e.g., a first polarity 210-1, a second polarity 210-2) when attempting to magnetically couple the constrained electronic device 102 to the auxiliary equipment 202. As the user 208 moves the constrained electronic device 102 closer to the auxiliary equipment 202 such that the magnetic alignment component 114 of the constrained electronic device 102 is within the magnetic field(s) of the complementary magnetic alignment component 206, the constrained electronic device 102 may be guided, magnetically, into a positionally-locked polarity 212 (e.g., positionally-locked polarity 212-1, positionally-locked polarity 212-2), as illustrated in the second stage 200-2. These positionally-locked polarities 212 may be based on the one or more patterns of the array of magnetic field-inducing components. Further, these positionally-locked polarities 212 may be at 45-degree stepwise rotational increments. As described herein, when the magnetic alignment component 114 of the constrained electronic device 102 and the complementary magnetic alignment component 206 of the auxiliary equipment 202 are magnetically coupled together, or even when not magnetically coupled together but under the influence of each other's magnetic field(s), they may comprise a rotationally-locking magnetic alignment system.

In one example, as illustrated in the first stage 200-1, the auxiliary equipment 202 may include an octagonal arrangement of magnetic field-inducing components. Each side of the octagonal arrangement of magnetic field-inducing components may include a first magnetic field-inducing component with a first magnetic polarity, a second magnetic field-inducing component with a second magnetic polarity, and a third magnetic field-inducing component with a third magnetic polarity. In implementations, the first, second, and/or third magnetic polarities can be a magnetic north polarity or a magnetic south polarity. For example only and not by way of limitation, the first magnetic polarity and the third magnetic polarity can be a north magnetic polarity, while the second magnetic polarity can be a south magnetic polarity. In this way, the magnetic alignment component 114 of the constrained electronic device 102 and the magnetic alignment component 206 of the auxiliary equipment 202 may magnetically attract each other and, therefore, be complementary.

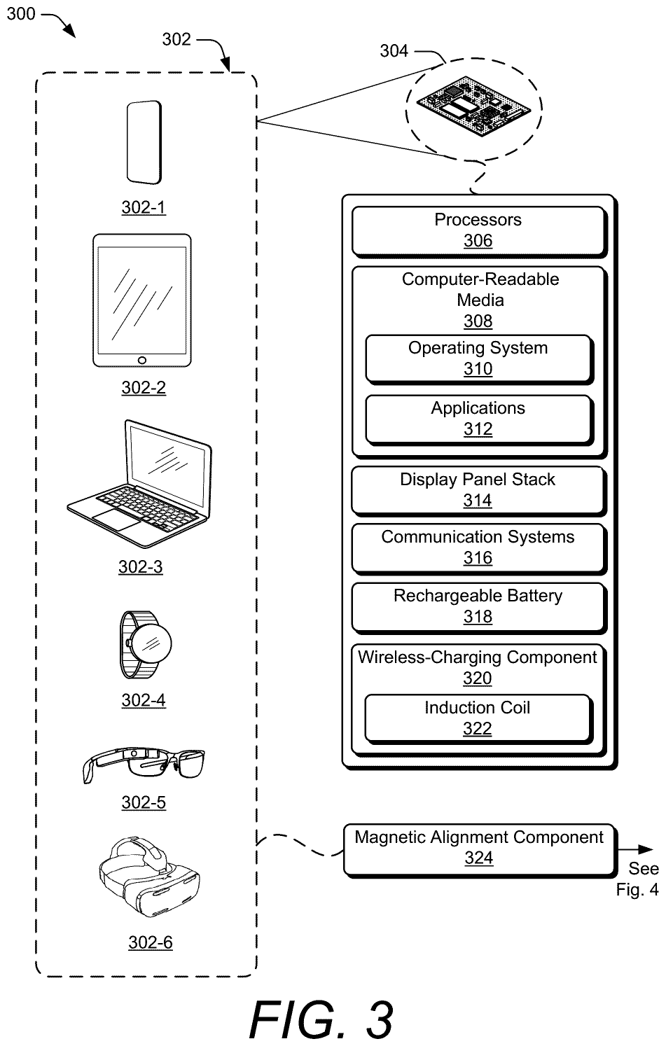

In more detail, FIG. 3 illustrates an example environment 300 that includes example constrained electronic devices (e.g., constrained electronic device 102), which are capable of implementing a magnetic alignment component (e.g., magnetic alignment component 114) in accordance with one or more implementations. Examples of a constrained electronic device 302 include a smartphone 302-1, a tablet 302-2, a laptop 302-3, a smartwatch 302-4, smart-glasses 302-5, and virtual-reality (VR) goggles 302-6. Although not shown, the constrained electronic device 302 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an IoT device, security systems, and the like. Note that the constrained electronic device 302 can be wearable, non-wearable but mobile, or relatively immobile (e.g., desktops, appliances). Further, the constrained electronic device 302, in implementations, may be an implanted device (e.g., devices that are embedded in the human body), including radiofrequency identification (RFID) microchips, near-field communication (NFC) microchips, and so forth. In additional implementations, the constrained electronic device 302 can be used with, or embedded within, electronic devices or peripherals, such as in automobiles (e.g., steering wheels) or as an attachment to a laptop computer. The constrained electronic device 302 may include components or interfaces omitted from FIG. 3 for the sake of clarity or visual brevity.

For example, although not shown, the constrained electronic device 302 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

As illustrated, the constrained electronic device 302 includes a printed circuit board assembly 304 (PCBA 304) on which components and interconnects of the constrained electronic device 302 are embodied. Alternatively or additionally, components of the constrained electronic device 302 can be embodied on other substrates, such as flexible circuit material or other insulative material, and, optionally, can be operatively coupled to the PCBA. The constrained electronic device 302 also includes a housing that defines at least one internal cavity. In implementations, the housing may be supported and/or defined by a frame. The housing includes an exterior surface and an opposing interior surface. The exterior surface may include at least one portion in contact with a physical medium (e.g., hair, skin, tissue, clothing) associated with a user or a physical medium (e.g., mount, pad) associated with an auxiliary equipment (e.g., auxiliary equipment 202). For example, a smartwatch 202-4 can include an exterior surface in contact with a charging stand. In aspects, the housing may be any of a variety of plastics, metals, acrylics, or glasses. In an implementation, the exterior surface of the housing includes one or more openings, such as a port.

Further illustrated, the PCBA 304 includes one or more processors 306 and computer-readable media 308. The processors 306 may include any suitable single-core or multi-core processor (e.g., an application processor (AP), a digital-signal processor (DSP), a central processing unit (CPU), graphics processing unit (GPU)). The processors 306 may be configured to execute instructions or commands stored within computer-readable media 308. The computer-readable media 308 can include an operating system 310 and applications 312. In at least some implementations, the operating system 310 and/or the applications 312 implemented as computer-readable instructions on the computer-readable media 308 can be executed by the processors 306 to provide some or all of the functionalities described herein. The computer-readable media 308 may be stored within one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

In some implementations, the housing may include and/or support a cover layer (e.g., cover glass) of a display panel stack 314. The display panel stack 314 may further include a display panel. The display panel stack 314 may be implemented as any one of an electroluminescent display (ELD), an active-matrix organic light-emitting diode display (AMOLED), a liquid crystal display (LCD), or the such. In additional implementations, the housing can support multiple cover layers for multiple display panels.

The PCBA 304 may further include and/or be operatively coupled to communication systems 316. The communication systems 316 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over communication systems 316 may be packetized or framed depending on a communication protocol or standard by which the constrained electronic device 302 is communicating. The communication systems 316 may include wired interfaces, such as Ethernet or fiber-optic interfaces for communication over a local network, private network, intranet, or the Internet. Alternatively or additionally, the communication systems 316 may include wireless interfaces that facilitate communication over wireless networks, such as wireless LANs, cellular networks, or WPANs.

The PCBA 304 further includes and/or is operatively coupled to a rechargeable battery 318 (e.g., a battery pack) that is configured to store and supply electrical energy. The rechargeable battery 318 may be any suitable rechargeable battery, such as a lithium-ion (Li-ion) battery. Various different Li-ion-battery chemistries may be implemented, some examples of which include lithium cobalt oxide (LiCoO₂), lithium iron phosphate (LiFePO₄), lithium manganese oxide (LiMn₂O₄ spinel, or Li₂MnO₃-based lithium-rich layered materials, LMR-NMC), and lithium nickel manganese cobalt oxide (LiNiMnCoO₂, Li-NMC, LNMC, NMC, or NCM and the various ranges of Co stoichiometry). Also, Li-ion batteries may include various different anode materials, including graphite-based anodes, silicon (Si), graphene, and other cation intercalation/insertion/alloying anode materials. The rechargeable battery 318 includes battery terminals for connection to a load and a power source.

In implementations, the wireless-charging component 320 includes any combination of electrical circuitry (e.g., wires, traces) and electrical components (e.g., capacitors, inductors) associated with wirelessly receiving, distributing, and/or providing electrical power. The wireless-charging component 320 includes an induction coil 322, which, in some implementations, is configured as the power source (e.g., to recharge the rechargeable battery) and, in additional implementations, is configured as the load (e.g., to wirelessly transmit electrical power to another constrained electronic device 302). The geometry of the induction coil 322 may be any suitable geometry, including a disk-like shape, a ring-like shape, a rectangular shape with rounded corners, and so forth. In some implementations, the geometry may be cylindrical to enable inductive resonance wireless charging. In further implementations, the induction coil 322 may be wound in a shape that substantially matches a geometry of another external induction coil. The induction coil 322 may be disposed adjacent and/or near to an inner surface of the housing of the constrained electronic device 302. Further, the induction coil 322 may be substantially parallel to a plane defined by at least one of the inner surface or the outer surface of the housing.

In one example, the wireless-charging component 320 can include an induction coil 322 composed of a bundle of flexible printed circuit board (FPCB) traces. The FPCB traces can be applied (e.g., printed) onto the FPCB to form a disk-like shape and in such a manner as to enable the traces to act as a plurality of separate, thin wires arranged in an electrically parallel configuration. In some implementations, the bundle of FPCB traces may form a Litz-wire structure, which may reduce the tendency of AC current to concentrate near the outer surface of a wire (“skin effect”). In a Litz-wire structure, multiple Litz wires may be wound together in each winding in a twisting pattern to reduce eddy current loss. By employing multiple traces, the coil disseminates AC current equivalently through all the traces and reduces the skin effect.

The constrained electronic device 302 further includes a magnetic alignment component 324 (e.g., magnetic alignment component 114). The magnetic alignment component 324 can include an array of magnetic field-inducing components that possess a particular magnetic polarity. The magnetic alignment component 324 may be compatible with Qi2 wireless charging standards. In implementations, the magnetic alignment component 324 at least partially surrounds the induction coil 322. In further implementations, the magnetic alignment component 324 is disposed within a housing component and/or within the internal cavity such that it is parallel to the induction coil 322, the inner surface of the housing, and/or the outer surface of the housing of the constrained electronic device 302.

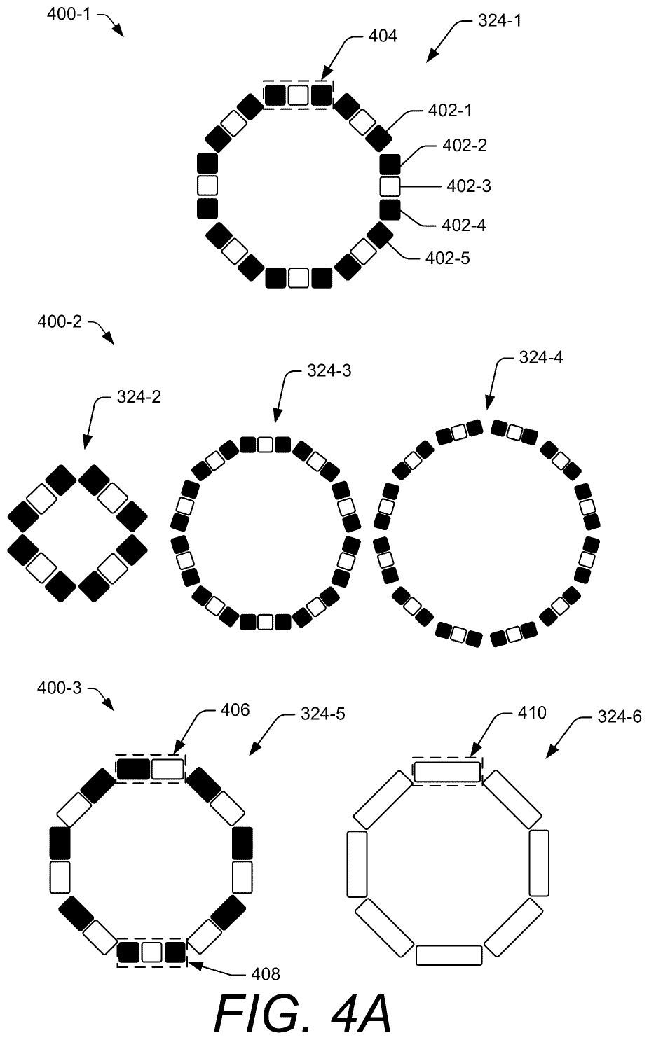

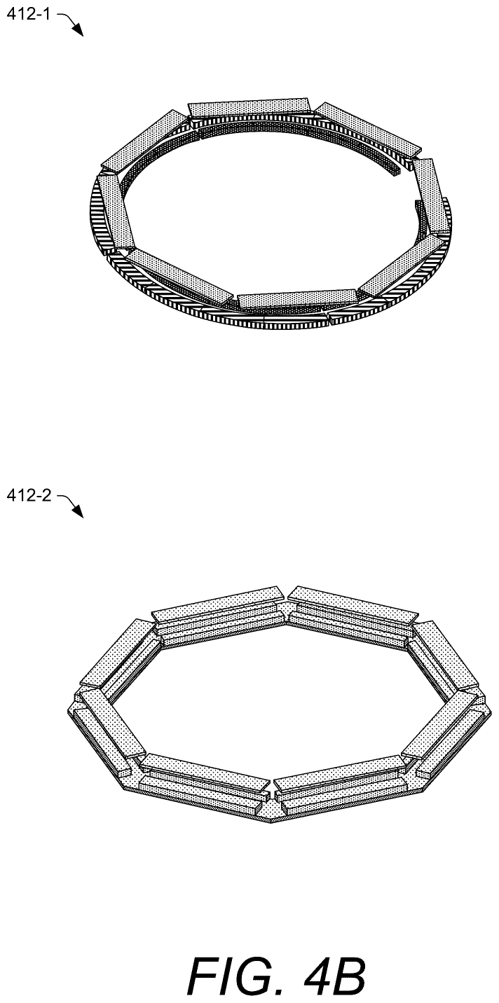

FIG. 4A illustrates a first detail view 400-1, a second detail view 400-2, and a third detail view 400-3 of example magnetic alignment components. The first detail view 400-1 illustrates an octagonal arrangement of an example magnetic alignment component 324-1. For instance, the example magnetic alignment component 324-1 includes an array of magnetic field-inducing components 402 that are arranged in such a way to substantially form an octagon. The magnetic field-inducing components 402 of one or more sides, for example side 404, of the octagonally-arranged magnetic alignment component 324-1 can be arranged in one or more patterns by magnetic polarity and/or magnetic field intensity. For example, magnetic field-inducing component 402-2 can have a first magnetic polarity, magnetic field-inducing component 402-3 can have a second magnetic polarity, and magnetic field-inducing component 402-4 can have a third magnetic polarity. In implementations, the first, second, and third magnetic polarities can be a north magnetic polarity or a south magnetic polarity. For instance, the first and third magnetic polarities can be a south polarity, while the second magnetic polarity can be a north polarity. Magnetic field-inducing component 402-1 and magnetic field-inducing component 402-5, which are adjacent to magnetic field-inducing component 402-2 and magnetic field-inducing component 402-4, respectively, can also have magnetic south polarities. In such an arrangement, the magnetic fields emanating from a single side of the octagonally-arranged magnetic alignment component 324-1 may be predominantly a magnetic south polarity. It will be apparent to those skilled in the art that the magnetic polarities detailed above may be switched.

The second detail view 400-2 illustrates a rectangularly-arranged magnetic alignment component 324-2, a decagonally-arranged magnetic alignment component 324-3, and a dodecagonally-arranged magnetic alignment component 324-4. The shapes of the magnetic alignment components in the second detail view 400-2 are provided by way of example only and not by limitation, for the shape of the magnetic alignment component 324 may form any polygon. The more sides of a shape in which the magnetic alignment component 324 is formed, the more positionally-locked polarities (e.g., positionally-locked polarities 212) may be available to orient the constrained electronic device 302. For example, the octagonally-arranged magnetic alignment component 324-1 may allow for eight positionally-locked polarities 212.

The magnetic field-inducing components 402 may include one or more permanent magnets (e.g., bar-type magnets), programmed magnets (e.g., magnetic structures that incorporate correlated patterns of magnets with alternating polarity), and/or electromagnets. The electromagnets may be activated by the one or more processors 306 at the instruction of the operating system 310 or the applications 312.

The third detail view 400-3 illustrates an octagonally-arranged magnetic alignment component 324-5. A first side 406 of the octagonally-arranged magnetic alignment component 324-5 may have only two magnetic field-inducing components 402, while a second side 408 may have three magnetic field-inducing components 402. In additional implementations, one or more sides of a magnetic alignment component (e.g., magnetic alignment component 324-5) can have no magnetic field-inducing components and may instead include a paramagnetic material, a diamagnetic material, or no materials. In further implementations, one or more sides of a magnetic alignment component can have one magnetic field-inducing component. In still further implementations, one or more sides of a magnetic alignment component can have as many as ten magnetic field-inducing components.

The third detail view 400-3 further illustrates an octagonally-arranged magnetic component 324-6. A first side 410 of the octagonally-arranged magnetic component 324-6 may have only one magnetic field-inducing component 402. In implementations, all sides of the octagonally-arranged magnetic alignment component 324-6 can include only one magnetic field-inducing component 402. It will be apparent to one skilled in the art that a magnetic field-inducing component 402 for a respective side of the one or more sides may be of a magnetic north or south orientation.

In addition to the above descriptions, the rotationally-locking magnetic alignment system can include one or more magnetic shunts. For example, one or more magnetic shunts (e.g., a highly permeable material) can redirect, adjust (e.g., strengthen), and/or control the flow of magnetic flux from the magnetic alignment component 324 and/or a magnetic alignment component (e.g., magnetic alignment component 206) of an auxiliary equipment (e.g., auxiliary equipment 202).

In implementations, the magnetic alignment component 324 can magnetically couple the constrained electronic device 302 to an auxiliary equipment (e.g., auxiliary equipment 202) with a complementary magnetic alignment component (e.g., magnetic alignment component 206). In additional implementations, the magnetic alignment component 324 can magnetically couple the constrained electronic device 302 to a diamagnetic material and/or a paramagnetic material. In further implementations, the magnetic alignment component 324 can magnetically couple the constrained electronic device 302 to a magnetic material that is not complementary.

FIG. 4B illustrates components of two example magnetic alignment systems. As illustrated, a first magnetic alignment system 412-1 includes an octagonally-arranged magnetic alignment component (e.g., magnetic alignment component 324-1, magnetic alignment component 324-2, magnetic alignment component 324-3, magnetic alignment component 324-4, magnetic alignment component 324-5, magnetic alignment component 324-6) magnetically coupling to a non-complementary, a semi-complementary, or a complementary but dimensionally disparate magnetic material.

In a first example, the magnetic alignment component 324 can magnetically couple the constrained electronic device 302 to an annular magnetic ring (e.g., a magnetic material that is at least partially complementary but dimensionally different than the octagonally-arranged magnetic alignment component). For example only and not by way of limitation, the annular magnetic ring may have a first magnetic polarity that attracts and magnetically couples the magnetic alignment component 324 with a second magnetic polarity (e.g., a predominant magnetic polarity). In further instances, the annular magnetic ring may have a first magnetic polarity and the magnetic alignment component 324 includes one or more electromagnets that cause the magnetic alignment component 324 to have a second magnetic polarity (e.g., a predominant magnetic polarity). In a second example, the magnetic alignment component 324 can magnetically couple the constrained electronic device 302 to a substantially flat surface that is diamagnetic or paramagnetic. In such an instance, the constrained electronic device 302 is free to rotate 360 degrees about an axis that is perpendicular to a contact surface between the outer surface of the housing of the constrained electronic device 302 and the flat surface.

In a third example, as illustrated by a second magnetic alignment system 412-2, the magnetic alignment component 324 can magnetically couple the constrained electronic device 302 to an auxiliary equipment 502 with a complementary magnetic alignment component. In at least some implementations, the auxiliary equipment 502 can have a semi-complementary magnetic alignment component that is dimensionally similar to the magnetic alignment component 324. For example, at least portions of the magnetic alignment component in the auxiliary equipment 502 include magnetic polarities that are complementary to the magnetic alignment component 324. The second magnetic alignment system 412-2 may provide rotational locking.

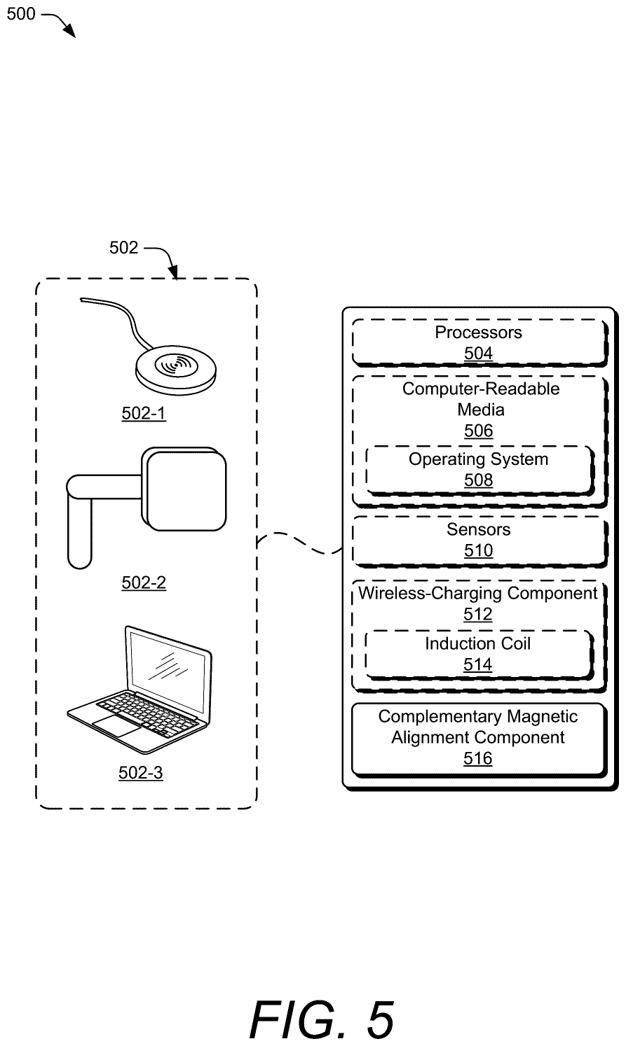

FIG. 5 illustrates an example environment 500 that includes example auxiliary equipment, which are capable of implementing a complementary magnetic alignment component in accordance with one or more implementations. As illustrated, the auxiliary equipment 502 may be implemented as a wireless charging pad 502-1, a mount 502-2, an electronic device 502-3, or the such. In additional implementations (not illustrated), the auxiliary equipment 502 may be implemented as a battery pack or a case. The auxiliary equipment 502 may include one or more processors 504 and computer-readable media 506. The computer-readable media 506 may include an operating system 508. In at least some implementations, the auxiliary equipment 502 includes a wireless-charging component 512 and an induction coil 514 (e.g., a transmitting induction coil, a receiving induction coil).

In implementations, the auxiliary equipment includes at least a complementary magnetic alignment component 516. Magnetic field-inducing components of the complementary magnetic alignment component 516 can be arranged in such a way that the magnetic alignment component 324 of the constrained electronic device 302 can be attracted to, magnetically coupled with, and positionally locked with the complementary magnetic alignment component 516. In implementations, the array of magnetic field-inducing components can be arranged in one or more patterns, within the magnetic alignment component 324 and the complementary magnetic alignment component 516, allowing for the first magnetic alignment component to be positionally locked at any number of stepwise rotational increments.

For instance, the magnetic alignment component 324 of the constrained electronic device 302 is in an octagonal arrangement and the complementary magnetic alignment component 516 of the auxiliary equipment 502 is also in an octagonal arrangement. However, where the sides of the magnetic alignment component 324 are predominantly of a magnetic south polarity, the sides of the complementary magnetic alignment component 516 are predominantly of a magnetic north polarity. Thus, rotational forces applied to the outer housing of the constrained electronic device 302 (e.g., rotational forces in a direction substantially parallel to a contact plane between the constrained electronic device 302 and the auxiliary equipment 502) are resisted by equal and opposite magnetic forces of the rotationally-locking magnetic alignment system.

In implementations, to reorient the constrained electronic device 302, a user may de-couple the magnetic alignment component 324 of the constrained electronic device 302 from the complementary magnetic alignment component 516 of the auxiliary equipment 502, orient the constrained electronic device 302, and then magnetically couple the two. In additional implementations, to reorient the constrained electronic device 302, the user may apply a rotational force to the constrained electronic device 302 sufficient to overcome the magnetic coupling force.

Through such a design, the magnetic alignment component 324 of the constrained electronic device 302 is compatible with Qi2 wireless charging standards. Moreover, such a design of the magnetic alignment component 324 and the complementary magnetic alignment component 516 enables the rotationally-locking magnetic alignment system to resist rotational forces acting on the constrained electronic device 302 that may otherwise cause the constrained electronic device 302 to reorient. For example, the rotationally-locking magnetic alignment system implemented between a smartphone and a mount in a vehicle may resist reorientation caused by, for example, jostling, bumps, acceleration, and so on.

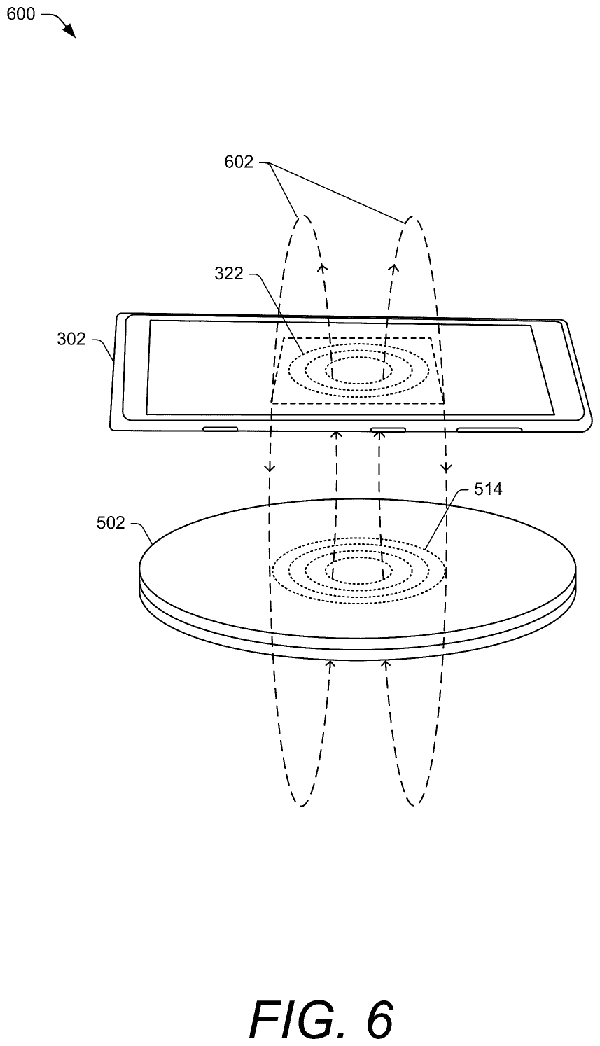

FIG. 6 illustrates an example environment 600 in which the auxiliary equipment 502 also wirelessly charges the constrained electronic device 302. Separation between the auxiliary equipment 502 and the constrained electronic device 302 is shown for illustrative purposes only. Due to the rotationally-locking magnetic alignment system implemented between the auxiliary equipment 502 and the constrained electronic device 302, induction coils (e.g., induction coil 322, induction coil 514) be may optimally aligned, resulting in quicker charge times and less power loss.

As illustrated, the constrained electronic device 302 can be charged by means of electromagnetic induction. Induction coil 322 of the constrained electronic device 302 can be positioned directly above the induction coil 514 of the auxiliary equipment 502 (e.g., charging station, inductive pad) due to the rotationally-locking magnetic alignment system. Inside the auxiliary equipment 502, alternating current (AC current) passes through the induction coil 514 and produces a fluctuating magnetic field 602 that propagates proportionally to a varying amplitude of the AC current. As a result, when the induction coil 322 (e.g., configured as a receiver coil) is positioned within the magnetic field 602, the magnetic field 602 generates an electromotive force that induces AC current in the induction coil 322. One or more electronic components (e.g., a rectifier) within the constrained electronic device 302 may then convert the induced AC current to direct current to charge the rechargeable battery 318 (not shown in FIG. 6).

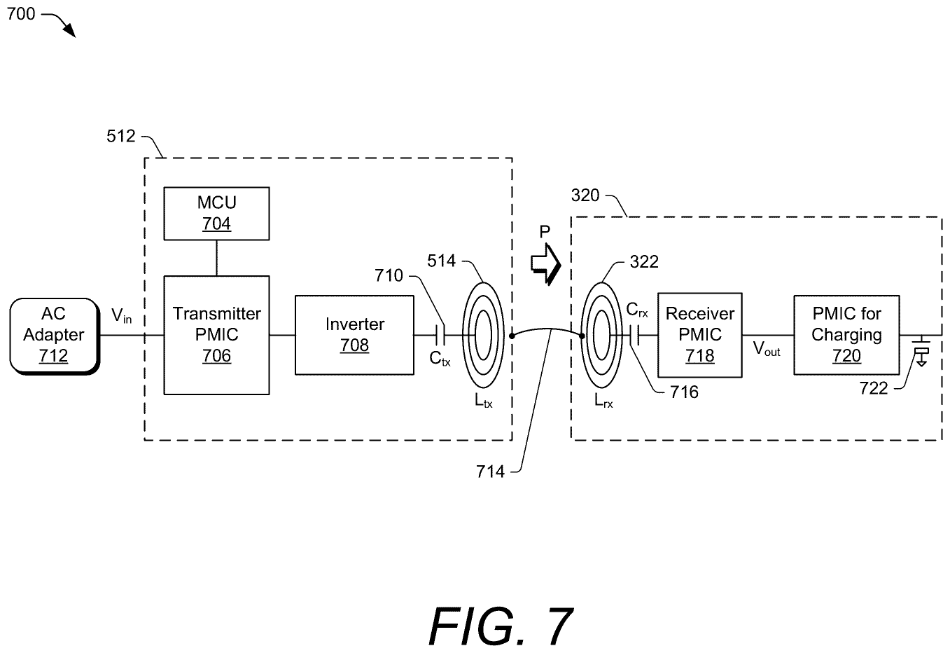

FIG. 7 illustrates a block diagram illustrating an example system 700 using the induction coil 514 for wireless charging of the constrained electronic device 302. The wireless-charging component 512 (e.g., a wireless-power transmitter) includes a microcontroller unit (MCU) 704 connected to a transmitter power management integrated circuit (PMIC) 706, which is connected to an inverter circuit 708 (e.g., full-bridge inverter circuit, half-bridge inverter circuit). The inverter circuit 708 is connected to one or more capacitors, such as capacitor (Ctx) 710. The capacitor 710 is connected to the induction coil 514 (Ltx 514). The system 700 also includes an AC adapter 712 coupled with an AC power supply. The AC adapter 712 provides an input voltage Vin, which is usable by the transmitter PMIC 706 and the MCU 704 to manage power driven to the induction coil 514. The inverter circuit 708 converts a DC input supply voltage (e.g., input voltage Vin) into symmetric AC voltage of a desired magnitude and frequency. The resultant AC voltage is output to the capacitor 710, which passes the energy to the induction coil 514.

The induction coil 514 generates a magnetic field 714 and couples to the induction coil 322 (Lrx) to transmit energy to the induction coil 322. The induction coil 322 receives the energy from the magnetic field 714 generated by the induction coil 514. This energy induces an electric current in the induction coil 322. The induction coil 322 passes energy from the electric current to one or more capacitors (Crx) 716, which then pass the energy to a receiver PMIC 718. The receiver PMIC 718 uses the energy provided by the one or more capacitors 716 to provide an output voltage Vout to a PMIC for charging 720. Additionally, the receiver PMIC 718 can provide load modulation back to the wireless-charging component 512 in accordance with Qi or Qi2 wireless charging standard. Load modulation signals can pass through the receiver coil 322 and on to the wireless-charging component 512 via the induction coil 514 to enable the wireless-charging component 512 to manage the amount of power being transmitted. Additionally, the wireless-charging component 512 may provide signals to the wireless-charging component 320 by using frequency modulation, such as frequency-shift keying (FSK). These modulated signals may pass through the induction coil 514 and on to the wireless-charging component 320 via the induction coil 322 to enable communication (e.g., control signals or feedback signals) from the wireless-charging component 512 to the wireless-charging component 320. The PMIC for charging 720 provides power management for quick charging of a load, such as load 722 (e.g., rechargeable battery 318), by providing a DC current at a voltage level of the load 722.

### CONCLUSION

Although aspects of the rotationally-locking magnetic alignment system have been described in language specific to features and/or methods, the subject of the appended claims is not necessarily limited to the specific features or methods described. Rather, the specific features and methods are disclosed as example implementations of the rotationally-locking magnetic alignment system, and other equivalent features and methods are intended to be within the scope of the appended claims. Further, various different aspects are described, and it is to be appreciated that each described aspect can be implemented independently or in connection with one or more other described aspects.

What is claimed is:

1. An apparatus comprising:
a housing having an interior surface and an exterior surface, the housing defining an internal cavity;
an induction coil disposed within the internal cavity adjacent to the interior surface, the induction coil substantially parallel to the exterior surface, the induction coil configured to receive electric energy via an electromotive force caused by a fluctuating magnetic field; and
a magnetic alignment component disposed proximate to the induction coil, the magnetic alignment component comprising multiple magnetic field-inducing components arranged in a polygonal shape, one or more sides of the polygonal shape comprise three magnetic field-inducing components, a first magnetic field-inducing component having a first magnetic field polarity, a second magnetic field-inducing component having a second magnetic field polarity, and a third magnetic field-inducing component having the first magnetic field polarity.

2. The apparatus of claim 1, wherein the magnetic field-inducing components comprise at least one of a permanent magnet or an electromagnet.

3. The apparatus of claim 1, wherein the magnetic alignment component is disposed coaxially with the induction coil.

4. The apparatus of claim 1, wherein each side of the polygonal shape comprises three magnetic field-inducing components, the first magnetic field-inducing component having the first magnetic field polarity, the second magnetic field-inducing component having the second magnetic field polarity, and the third magnetic field-inducing component having the first magnetic field polarity.

5. The apparatus of claim 1, wherein the first magnetic field-inducing component and the third magnetic field-inducing component comprise greater magnetic field intensities than a magnetic field intensity of the second magnetic field-inducing component.

6. The apparatus of claim 1, wherein the polygonal shape comprises an octagon.

7. The apparatus of claim 1, wherein at least one side of the polygonal shape comprises two magnetic field-inducing components, a fourth magnetic field-inducing component having the first magnetic field polarity, a fifth magnetic field-inducing component having the second magnetic field polarity.
